(19) United States
(12) Patent Application Publication
(10) Pub. No.: US 2005/0025892 A1
(43) Pub. Date: Feb. 3, 2005

(54) Composition for porous organic film

(75) Inventors: Naoya Satoh, Tsukuba-shi (JP); Yuji Yoshida, Tokyo (JP); Akira Yokota, Matsudo-shi (JP)

Correspondence Address: FOLEY AND LARDNER;SUITE 500, 3000 K STREET NW, WASHINGTON, DC, 20007, US

(73) Assignee: SUMITOMO CHEMICAL COMPANY, LIMITED

(21) Appl. No.: 10/694,400

(22) Filed: Oct. 28, 2003

(30) Foreign Application Priority Data
Nov. 1, 2002 (JP) 2002-319508
Jun. 25, 2003 (JP) 2003-180648

(51) Int. Cl. B05D 3/02

(52) U.S. Cl. 427/385.5; 427/372.2

(57) ABSTRACT

The present invention provides a composition comprising the following (A) and (B): (A) at least one selected form the group consisting of an aromatic polymer having a repeating unit of the following formula (1) and a monomer having in the molecule at least two —C≡CH groups,
(B) at least one selected form the group consisting of a heat transpirable compound and a heat decomposable compound:

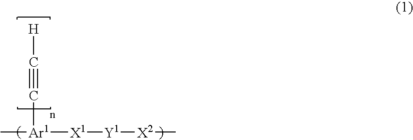

### FIELD OF THE INVENTION

The present invention relates to a porous organic film-forming composition.

### BACKGROUND OF THE INVENTION

As the device dimension shrink to the sub-micron region, the propagation delay and cross-talk noise due to resistance capacitance (RC delay). Reduction of capacitance by the use of lower dielectric materials was considered as the main solution to the delay problem. Therefore, development of a material capable of producing an insulation film of low dielectric constant is being progressed.

As the material of an insulation film of low dielectric constant, there is known, for example, a composition composed of a polymer obtained by oxidative-polymerization, in the presence of a catalyst, of an aromatic compound containing two or more ethynyl groups in the molecule (JP2002-155233A). However, an insulation film obtained from this composition has a relative dielectric constant of 2.7 to 2.9 which is not recognized to be fully satisfactory.

An object of the present invention is to provide a porous organic film-forming composition from which an insulation film of low dielectric constant can be produced.

### SUMMARY OF THE INVENTION

The present inventors have intensively studied a composition capable of solving the problem as described above, and resultantly found that a porous organic film-forming composition comprising a compound having a —C≡CH group in the molecule and a heat transpirable compound and/or heat decomposable compound can be used to produce an insulation film of low dielectric constant, and have completed the invention.

The present invention relates to a composition for porous organic film comprising the following (A) and (B):
(A) an aromatic polymer having a repeating unit of the following formula (1) or a monomer having in the molecule at least two —C≡CH groups, and
(B) at least one selected from the group consisting of a heat transpirable compound and a heat decomposable compound: 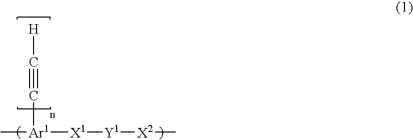
   in the formula (1), Ar¹ represents a group having an aromatic ring optionally substituted by other group than a —C≡CH group, X¹ and X² each independently represents a direct bond, an alkylene group having 1 to 20 carbon atoms optionally substituted, —CR¹═CR²—, —C≡C—, a divalent group having an aromatic ring optionally substituted, a divalent group having an alicyclic hydrocarbon ring optionally substituted, —O—, —CO—, —COO—, —S—, —SO—, —SO₂—, —NR³— or —CONR⁴—, R¹ to R⁴ each independently represents a hydrogen atom or an alkyl group having 1 to 20 carbon atoms optionally substituted, an alkoxy group having 1 to 20 carbon atoms optionally substituted, an alicyclic hydrocarbon group having 4 to 20 carbon atoms optionally substituted or an aryl group optionally substituted, and Y¹ represents a divalent organic group. n represents an integer of 1 or more.

### DESCRIPTION OF PREFERRED EMBODIMENTS

The composition used for porous organic film of the present invention comprises the following (A) and (B).
(A) An aromatic polymer having a repeating unit of the above-described formula (1) or a monomer having in the molecule at least two —C≡CH groups.
(B) at least one selected from the group consisting of a heat transpirable compound and a heat decomposable compound.

In the formula (1), Ar¹ represents a group having an aromatic ring optionally substituted by other group than a —C≡CH group.

The group having an aromatic ring includes, for example, a group having a benzene ring, diphenyl ring, naphthalene ring, anthracene ring, fluorene ring, pyridine ring, pyrazine ring, pyrimidine ring, pyridazine ring or triazine ring.

Examples of the other group than a —C≡CH group include, for example, alkyl groups, alkoxy groups, alkenyl groups, alkynyl groups other than a —C≡CH group, aryl groups, trialkylsilyl groups optionally having a substituent, hydroxyl group.

Examples of the alkyl group as a substituent include, for example, a methyl group, ethyl group, n-propyl group, isopropyl group, butyl group, isobutyl group, pentyl group, hexyl group.

Examples of the alkoxy group as a substituent include, for example, a methoxy group, ethoxy group, propoxy group.

Examples of the alkenyl group as a substituent include, for example, a vinyl group, allyl group, butenyl group, pentenyl group, hexenyl group, 2-methylallyl group, butadienyl group.

Examples of the alkynyl groups other than a —C≡CH group as a substituent include, for example, a propargyl group, butynyl group, pentynyl group, butadiynyl group, heptynyl group and the like.

Examples of the aryl group as a substituent include, for example, a phenyl group, diphenyl group, naphthyl group, anthracenyl group, fluorenyl group, pyridinyl group, pirazinyl group, pyrimidyl group, pyridazinyl group, triazinyl group.

Examples of the trialkylsilyl group as a substituent include, for example, a trimethylsilyl group, triethylsilyl group, triisopropylsilyl group, dimethylethylsilyl group.

As Ar¹, the examples of groups may shown below.

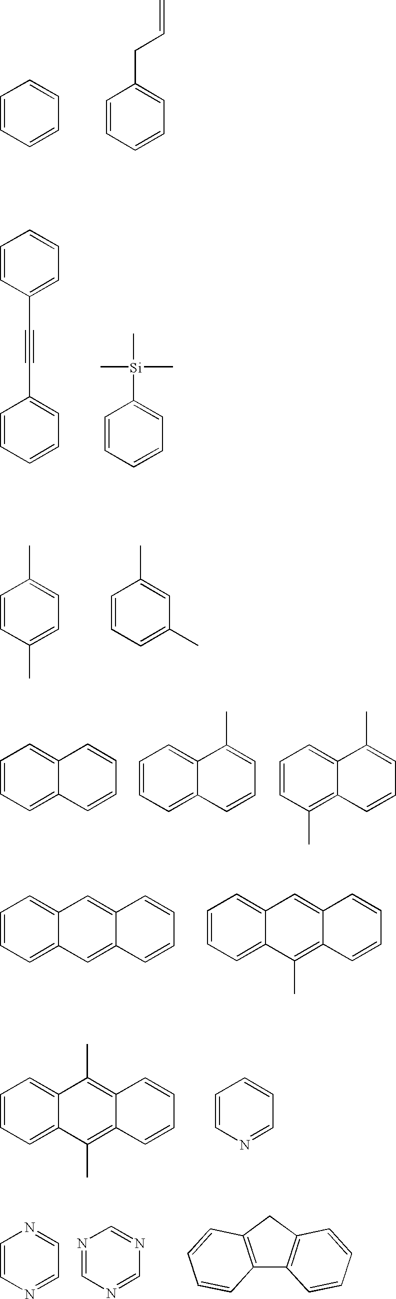

X¹ and X² each independently represents a direct bond, an alkylene group having 1 to 20 carbon atoms optionally substituted, —CR¹═CR²—, —C≡C—, a divalent group having an aromatic ring optionally substituted, a divalent group having an alicyclic hydrocarbon ring optionally substituted, —O—, —CO—, —COO—, —S—, —SO—, —SO₂—, —NR³— or —CONR⁴.

Examples of the alkylene group having 1 to 20 carbon atoms include, for example, a methylene group, ethylene group, n-propylene group, isopropylene group, butylene group, isobutylene group, pentylene group, hexylene group.

The substituent on alkylene group having 1 to 20 carbon atoms includes, for example, alkoxy groups, alkenyl groups, alkynyl groups other than a —C≡CH group, aryl groups, trialkylsilyl groups optionally having a substituent, hydroxyl group.

The examples of alkoxy groups, alkenyl groups, alkynyl groups other than a —C≡CH group, aryl groups and trialkylsilyl groups optionally having a substituent include the same groups as described above.

R¹ to R⁴ in —CR¹═CR²—, —NR³— and —CONR⁴— each independently represents a hydrogen atom, an alkyl group having 1 to 20 carbon atoms optionally substituted, an alkoxy group having 1 to 20 carbon atoms optionally substituted, an alicyclic hydrocarbon group having 4 to 20 carbon atoms optionally substituted or an aryl group optionally substituted.

Examples of the alkyl group having 1 to 20 carbon atoms include, for example, a methyl group, ethyl group, n-propyl group, isopropyl group, butyl group, isobutyl group, pentyl group, hexyl group.

The substituent on the alkyl group having 1 to 20 carbon atoms includes, for example, alkoxy groups, alkenyl groups, alkynyl groups other than a —C≡CH group, aryl groups, trialkylsilyl groups optionally having a substituent, hydroxyl group.

The alkoxy groups, alkenyl groups, alkynyl groups other than a —C≡CH group, aryl groups and trialkylsilyl groups optionally having a substituent include the same groups as described above.

Examples of the alkoxy group having 1 to 20 carbon atoms include, for example, a methoxy group, ethoxy group, n-propoxy group, isopropoxy group, butoxy group, isobutoxy group, pentyloxy group, hexyloxy group.

The substituent on the alkoxy group having 1 to 20 carbon atoms includes, for example, alkyl groups, alkenyl groups, alkynyl groups other than a —C≡CH group, aryl groups, trialkylsilyl groups optionally having a substituent, hydroxyl group.

The alkyl groups, alkenyl groups, alkynyl groups other than a —C≡CH group, aryl groups and trialkylsilyl groups optionally having a substituent include the same groups as described above.

Examples of the alicyclic hydrocarbon group having 4 to 20 carbon atoms include, for example, a cyclobutyl group, cyclopentyl group, cyclohexyl group, cycloheptyl group, adamantyl group, norbornyl group.

The substituent on the alicyclic hydrocarbon group having 4 to 20 carbon atoms includes, for example, alkyl groups, alkoxy groups, alkenyl groups, alkynyl groups other than a —C≡CH group, aryl groups, trialkylsilyl groups optionally having a substituent, hydroxyl group.

The alkyl groups, alkoxy groups, alkenyl groups, alkynyl groups other than a —C≡CH group, aryl groups and trialkylsilyl groups optionally having a substituent include the same groups as described above.

Examples of the aryl group include, for example, a phenyl group, diphenyl group, naphthyl group, anthracenyl group, fluorenyl group, pyridinyl group, pirazinyl group, pyrimidyl group, pyridazinyl group, triazinyl group.

The substituent on the aryl group include, for example, alkyl groups, alkoxy groups, alkenyl groups, alkynyl groups other than a —C≡CH group, trialkylsilyl groups optionally having a substituent, hydroxyl group.

The alkyl groups, alkoxy groups, alkenyl groups, alkynyl groups other than a —C≡CH group and trialkylsilyl groups optionally having a substituent include the same groups as described above.

A —CR¹═CR²— includes, for example, one of the following groups.

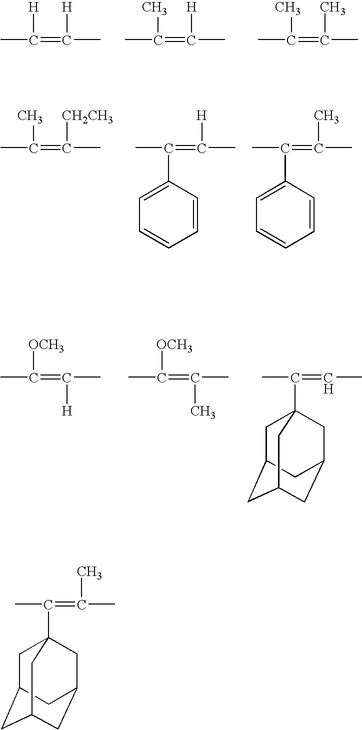

A —NH³— include, for example, one of the following groups.

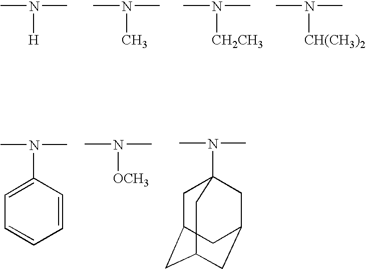

A —CONR⁴— include, for example, one of the following groups.

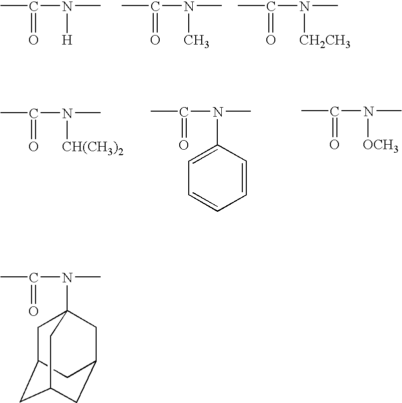

Y represents a divalent organic group, and particularly a divalent group having an aromatic ring is preferable from the viewpoint of its high heat resistance. Examples of the divalent group having an aromatic ring include, for example, groups of the following formula (2) or the formula (3).

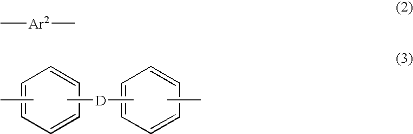

In the divalent group having an aromatic ring of the formula (2), an aromatic ring include, for example, a benzene ring, diphenyl ring, naphthalene ring, anthracene ring, fluorene ring, pyridine ring, pyrazine ring, pyrimidine ring, pyridazine ring or triazine ring.

In the divalent group having an alicyclic hydrocarbon ring of the formula (2), an alicyclic hydrocarbon ring include, for example, a cyclobutyl ring, cyclopentyl ring, cyclohexyl ring, cycloheptyl ring, adamantyl ring, norbornyl ring.

The substituent on them include, for example, alkyl groups, alkoxy groups, alkenyl groups, alkynyl groups other than a —C≡CH group, trialkylsilyl groups optionally having a substituent, hydroxyl group.

The alkyl groups, alkoxy groups, alkenyl groups, alkynyl groups other than a —C≡CH group and trialkylsilyl groups optionally having a substituent include the same groups as described above.

In the formula (3), D represents —CR⁵R⁶—, —CR⁷═CR⁸—, —C≡C—, divalent group having an aromatic ring optionally substituted, divalent group having an alicyclic hydrocarbon ring optionally substituted, —O— or —CO—.

R⁵ to R⁸ each independently represents a hydrogen atom, an alkyl group having 1 to 20 carbon atoms optionally substituted, an alkoxy group having 1 to 20 carbon atoms optionally substituted, an alicyclic hydrocarbon group having 4 to 20 carbon atoms optionally substituted, or an aryl group optionally substituted.

The alkyl group having 1 to 20 carbon atoms, alkoxy group having 1 to 20 carbon atoms, alicyclic hydrocarbon group having 4 to 20 carbon atoms, aryl group include, and the substituent on them include, the same groups as described above. —CR⁵R⁶— include, for example, a methylene group, ethylidene group, n-propylidene group, isopropylidene group, butylidene group, isobutylidene group, pentylidene group, hexylidene group. —CR⁷=CR⁸— include the same groups as described above.

As the group of the formula (2) or the formula (3), there are listed divalent groups having, for example, a benzene ring, diphenyl ring, naphthalene ring, anthracene ring, fluorene ring, pyridine ring, pyrazine ring, pyrimidine ring, pyridazine ring or triazine ring, and the like.

From the viewpoint of heat resistance, those of the above-mentioned formula (2) in which Ar² represents a phenylene group, diphenylene group or naphthylene group, and those of the above-mentioned formula (3) in which D represents —C≡C—, phenylene group or fluorenine group, are preferable, and those of the above-mentioned formula (3) in which D represents —C≡C— or fluorenine group are more preferable.

The aromatic polymer having a repeating unit of the above-mentioned formula (1) include, for example, polyphenylenes, polyimides, polyarylene ethers, polyarylene ether ketones, polyarylene ether sulfones, polyarylene ether amides, and polyarylene ethers are preferable.

Particularly, in the formula (1), polyarylene ethers in which X¹ and X² represent O, and y¹ represents a divalent group having an aromatic ring are preferably used. Polymers having an ether bond in the main chain as describe above are preferably used from the viewpoint of heat resistance, insulation property (relative dielectric constant: 3.0 or less), solubility in organic solvents.

Those in which Y¹ is represented by the above-mentioned formula (3) and D represents —C≡C— or fluorenine group are more preferably used from the viewpoint of further excellent in heat resistance.

Further, a cross-linkable group such as an epoxy group, cyanate group, propargyl group, allyl group, vinyl group, ethynyl group, alkylsilyl group, alkoxysilyl group or the like may be carried on the main chain, side chain or end of the above-mentioned formula (1).

The weight-average molecular weight of the aromatic polymer having a repeating unit of the formula (1) base on a polystyrene calibration standard according to gel permeation chromatography (hereinafter, abbreviated as GPC) is preferably 50000 or less, more preferably 30000 or less, further preferably 10000 or less.

When this molecular weight is over 50000, its solubility in a solvent, applicability on a substrate, and the like may be deteriorated.

The preferable monomer having in the molecule at least two —C≡CH groups is a monomer further having an aromatic ring.

The monomer include, for example, monomers of the following groups (4) or the group (5). 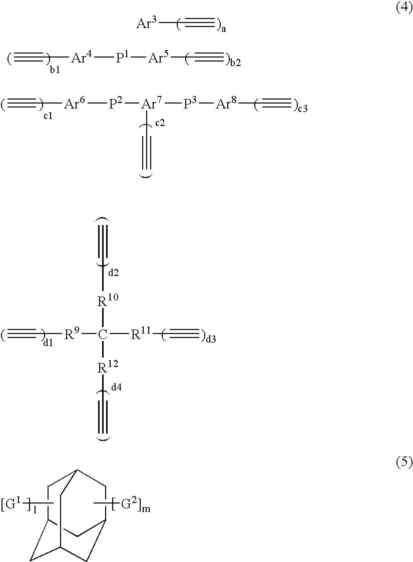
In (5), 1 represents an integer of 2 to 16 and m=16-1, and G¹s may be mutually the same or different, and represent an ethynyl group, an organic group of the formula (6) or an organic group of the formula (7), when a plurality of G²s are present, they may be mutually the same or different, and represent a hydrogen atom, halogen atom, hydroxyl group, alkyl group having 1 to 6 carbon atoms, alkoxy group having 1 to 6 carbon atoms, phenoxy group or aryl group optionally substituted.
—T¹—Ar⁹—(C≡C—A)ₚ (6)
In the formula (6), T¹ represents a direct bond, an alkylene group having 1 to 6 carbon atoms, alkenylene group having 2 to 6 carbon atoms or an alkynylene group having 2 to 6 carbon atoms. p represents an integer of 1 to 5, Ar⁹ represents an arylene group optionally substituted. A represents a hydrogen atom or an aryl group optionally substituted, and when p is 2 or more, As may be the same or different, however, at least one of them is a hydrogen atom.
—Ar¹⁰—T²—Ar¹¹—(C≡C—B)_{q} (7)
wherein, q represents an integer of 1 to 5, and Ar¹⁰ and Ar¹¹ represent an arylene group optionally substituted. T² represents —O—, —CO—, —COO—, —S—, —SO— or —SO₂—. B represents a hydrogen atom or an aryl group optionally substituted, and when q is 2 or more, Bs may be the same or different, however, at least one of them is a hydrogen atom.

In the formula (4), Ar³ to Ar⁸ each independently represents a group having an aromatic ring optionally substituted by other group than —C≡C—H group.

The groups having an aromatic ring include, and the substituents on it include, the same groups as described above.

Here, R⁹ to R¹² each independently represents a hydrogen atom or an alkyl group having 1 to 20 carbon atoms, an alkoxy group having 1 to 20 carbon atoms, an alicyclic hydrocarbon group having 4 to 20 carbon atoms, an aryl group or hydroxyl group, and the alkyl group having 1 to 20 carbon atoms, alkoxy group having 1 to 20 carbon atoms, alicyclic hydrocarbon group having 4 to 20 carbon atoms and aryl group may be substituted by other group than —C≡C—H group.

At least one of R⁹ to R¹² is selected from groups having an aromatic ring optionally substituted by other group than —C≡C—H group.

The alkyl group having 1 to 20 carbon atoms, alkoxy group having 1 to 20 carbon atoms, alicyclic hydrocarbon group having 4 to 20 carbon atoms, aryl group, hydroxyl group and as the substituent on them, include the same groups as described above.

P¹ to p³ each independently represents a direct bond, —C≡C—, —O—, —CO—, —COO—, —S—, —SO—, —SO₂—, —CONH—, —NR¹³— or a divalent group having an aromatic ring optionally substituted.

The divalent groups having an aromatic ring and the substituents on it include the same groups as described above.

R¹³ represents a hydrogen atom or an alkyl group having 1 to 20 carbon atoms optionally substituted, an alkoxy group having 1 to 20 carbon atoms optionally substituted, an alicyclic hydrocarbon group having 4 to 20 carbon atoms optionally substituted, an aryl group optionally substituted or hydroxyl group.

The alkyl group having 1 to 20 carbon atoms, alkoxy group having 1 to 20 carbon atoms, alicyclic hydrocarbon group having 4 to 20 carbon atoms and aryl group and as the substituent on them include the same groups as described above.

a represents an integer of 2 or more, b1, b2, c1 to c3 and d1 to d4 each independently represents an integer of 0 or more, and b1+b2, c1+c2+c3 and d1+d2+d3+d4 represent an integer of 2 or more.

The examples of these monomers include, for example, monomers of the following groups.

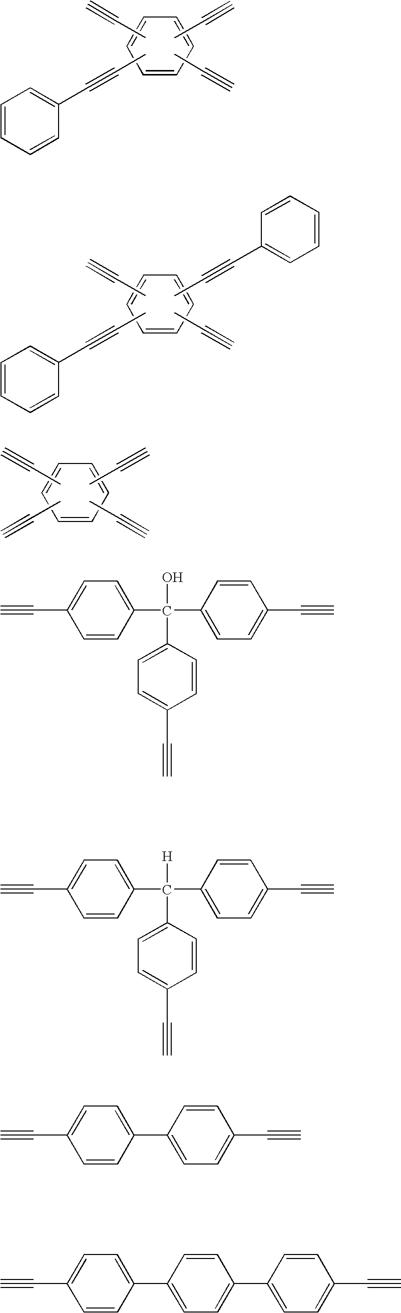

In the formula (5), G¹s may be mutually the same or different, and represent an ethynyl group, an organic group of the formula (6) or an organic group of the formula (7).

In the formula (6), T¹ represents a direct bond, an alkylene group having 1 to 6 carbon atoms, alkenylene group having 2 to 6 carbon atoms or an alkynylene group having 2 to 6 carbon atoms. A represents a hydrogen atom or an aryl group optionally substituted, and when p is 2 or more, As may be the same or different, however, at least one of them is a hydrogen atom.

As the alkylene group having 1 to 6 carbon atoms, there are listed, for example, a methylene group, ethylene group, propylene group, hexylene group and the like.

The alkenylene group having 2 to 6 carbon atoms, alkynylene group having 2 to 6 carbon atoms and the aryl group optionally substituted include the same groups as described above.

Examples of Ar⁹ include a phenylene group, alkylphenylene groups such as a methylphenylene group, dimethylphenylene group, ethyl phenylene group, diethylphenylene group, trimethylphenylene group, tetramethylphenylene group, pentamethylphenylene group and the like, alkoxyphenylene groups such as a methoxyphenylene group, ethoxyphenylene group and the like, halophenylene groups such as a fluorophenylene group, chlorophenylene group, bromophenylene group, iodophenylene group and the like, alkylnaphthylene groups such as a methylnaphthylene group, dimethylnaphthylene group, ethylnaphthylene group, diethylnaphthylene group, trimethylnaphthylene group, tetramethylnaphthylene group, pentamethylnaphthylene group and the like, alkoxynaphthylene groups such as a methoxynaphthylene group, ethoxynaphthylene group and the like, halonaphthylene groups such as a fluoronaphthylene group, chloronaphthylene group, bromonaphthylene group, iodonaphthylene group and the like; a hydroxyphenylene group, phenoxyphenylene group, nitrophenylene group, cyanophenylene group, carboxyphenylene group, methyloxycarbonylphenylene group, aminophenylene group, naphthylene group, hydroxynaphthylene group, phenoxynaphthylene group, nitronaphthylene group, cyanonaphthylene group, carboxynaphthylene group, methyloxycarbonylnaphthylene group, aminonaphthylene group, biphenylene group, anthracelenegroup and the like.

p represent an integer of 1 to 5, and particularly, p is preferably 1 or 2.

In the formula (7), q represents an integer of 1 to 5, and Ar¹⁰ and Ar¹¹ represent an arylene group optionally substituted. T² represents —O—, —CO—, —COO—, —S—, —SO— or —SO₂—. B represents a hydrogen atom or an aryl group optionally substituted, and when q is 2 or more, Bs may be the same or different, however, at least one of them is a hydrogen atom.

The arylene group Ar¹⁰ or Ar¹¹ optionally substituted include the same groups as for the above-mentioned Ar⁹. q represent an integer of 1 to 5, and particularly, q is preferably 1 or 2.

More preferably, G¹ is an organic group selected from the following groups.

When G¹ is an organic group selected from the following groups, alkylene groups react mutually and the chemical structure becomes an aromatic ring, polyvinylene skeleton or polyacetylene skeleton, the resulted insulation film may be enhanced mechanical strength, such an organic group is more preferable. T² preferably represents O or CO from the viewdpoint of dielectric constant.
—C≡CH
—Ar⁹(—C≡CA)_{P}—C≡C—Ar⁹(—C≡CA)ₚ
—Ar¹⁰—O—Ar¹¹(—C≡CB)_{q}—Ar¹⁰—CO—Ar¹¹(—C≡CB)_{q}
wherein, Ar⁹, Ar¹⁰, Ar¹¹, A, B, p and q are as defined above.

Further, when G¹ is a monovalent organic group selected from the following groups, an insulation film having low polarizability and low relative dielectric constant may be obtained, such an organic group is more preferable. 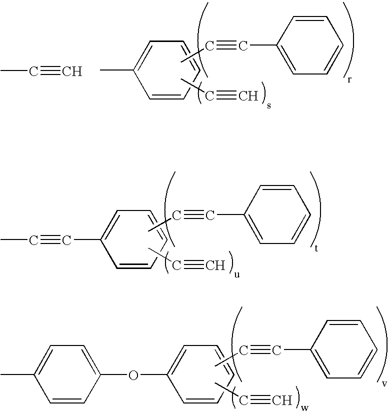
wherein, r, t and v represent an integer of 0 to 5, s, u and w represents an integer of 1 to 5, r+s represents 1 to 5, t+u represents 1 to 5 and v+w represents 1 to 5.

It is particularly preferable that G¹ is a monovalent or divalent organic group selected from the following groups.

Monovalent or divalent organic groups selected from the following groups are particularly preferable from the viewpoint of the easy availablity of raw materials such as acetylene, ethynylbenzene, diphenylacetylene and ethynyldiphenylacetylene.

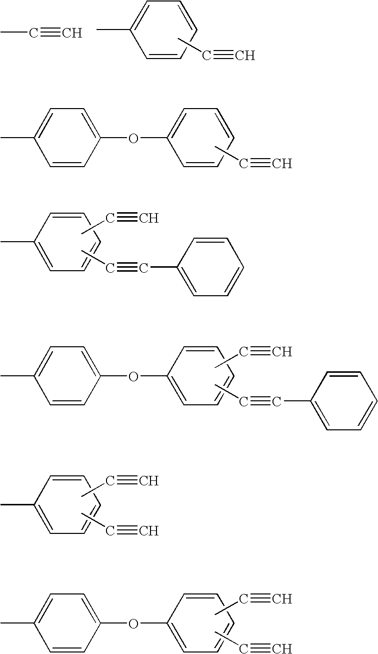

G² represents a hydrogen atom, halogen atom, hydroxyl group, alkyl group having 1 to 6 carbon atoms, alkoxy group having 1 to 6 carbon atoms, phenoxy group or aryl group optionally substituted, and G² S may be the same or different.

The halogen atom include a fluorine atom, chlorine atom, bromine atom and iodine atom.

Example of the alkyl group having 1 to 6 carbon atoms include, for example, a methyl group, ethyl group, propyl group, butyl group, hexyl group.

Example of the alkoxy group having 1 to 6 carbon atoms include, for example, a methoxy group, ethoxy group, propoxy group, butoxy group, hexoxy group.

The aryl groups optionally substituted include the same groups as describe above.

G² is preferably a hydrogen atom, hydroxyl group or aryl group optionally substituted, and more preferably, a hydrogen atom.

1 represents an integer of 2 to 16, and m=16-1.

Regarding adamantane derivative as the starting material, from the viewpoint that adamantane is easily obtained industrially and a methine group of an adamantane molecule has high reactivity, the compound of the formula (5) is preferably one of compounds as shown in (8). The number of G¹ is preferably from 2 to 3 per molecule of adamantane from the viewpoint of the productivity. 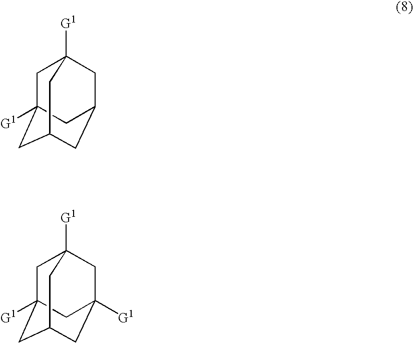
wherein, G¹ is as defined above.

The method of obtaining compounds of (8) using adamantane as a starting material is not particularly restricted. In one example, a cross-linking methine group of adamantane is halogenated with chlorine, bromine, iodine and the like, then, a coupling reaction is caused with an aryl halide such as bromobenzene, iodobenzene, dibromobenzene, diiodobenzene, bromo diphenyl ether, dibromo diphenyl ether and the like using as a catalyst a Lewis acid such as aluminum chloride, tin chloride, antimony chloride, titanium chloride, aluminum bromide, tin bromide, antimony bromide, titanium bromide and the like to bond the aryl halide to a methine group of adamantane, further, a halogen group bonded to an aryl group is coupled with acetylene or ethynylbenzene using an Sonogashira reaction, to obtain a compound of (8). In the case of acetylene, it may also be permissible to use a method of conducting de-protection after coupling reaction, using a compound obtained by substituting one of acetylene hydrogens with a protective group such as a trimethylsilyl group, tributyltin group, 1-hydroxy-1-methylethyl group or the like.

The weight-average molecular weight of a monomer having in the molecule at least two —C≡CH groups based on a polystyrene calibration standard according to GPC is preferably 5000 or less, more preferably 3000 or less, further preferably 1500 or less.

When this molecular weight is over 5000, cross-linking density may lower and decrease in relative dielectric constant may not be sufficient by decrease in the ratio of a —C≡CH group in the molecule.

The composition for porous organic film of the present invention contains a heat transpirable compound, a heat decomposable compound or a mixture of them.

When the heat decomposition initiation temperature of an aromatic polymer and/or a compound after cross-linking of a monomer having in the molecule at least two —C≡CH groups is represented by Ta and the heat transpiration initiation temperature of a heat transpirable compound or a heat decomposition initiation temperature of a heat decomposable compound is represented by Tb, it is preferable that Ta and Tb satisfy the relation of Ta>Tb.

It is more preferable that Ta satisfies the relation of Ta>Tb and is a temperature over 350° C., and further preferable, over 400° C. From the viewpoint that heat treatment is usually conducted at 350° C. or more, further at 400° C. or more in a thin film formation process in production of an electronic part, particularly a semiconductor apparatus, the porous organic film of the present invention preferably has heat resistance against this temperature.

Here, Tb is a temperature measured under a condition of a temperature raising speed of 10° C./minute under nitrogen flow by TG/DTA (differential heat, thermogravimetric apparatus), in 5% weight reduction. Tb is preferably 300° C. or less, more preferably 250° C. or less, further preferably 230° C. or less, with the premise satisfying the relation of Ta>Tb. Tb is preferably 200° C. or more.

When Tb is over 300° C., a heat transpirable compound is not completely transpired or a heat decomposable compound is not completely decomposed in some cases at an insulation film formation completion temperature, a void may not be formed, and when less than 200° C., transpiration of a heat transpirable compound or decomposition of a heat decomposable compound may occur before cross-linking of (A) and a void may not be formed.

The heat transpirable compound include, for example, adamantane derivatives, norbornene derivatives, hydroxynaphthalene derivatives, hydroxyanthracene derivatives.

The heat decomposable compound include, for example, polystyrene derivatives, polyoxyalkylene derivatives, polyacrylate derivatives, polyalkylene glycol derivatives, polyurethanes, polyamides, polyesters, polycarbonates and the like.

Among them, polystyrene derivatives and polyoxyalkylene derivatives are preferably used.

Examples of the polystyrene derivative include polystyrene, polyvinyltoluene, polyvinylxylene, poly α-methylstyrene, poly α-methylvinyltoluene, poly α-methylvinylxylene, poly α-ethylstyrene, poly α-ethylvinyltoluene, poly α-ethylvinylxylene and the like.

Among them, polystyrene, polyvinyltoluene, poly α-methylstyrene and poly α-methylvinyltoluene are more preferable, and polystyrene and poly α-methylstyrene are further preferable.

Examples of the polyoxyalkylene derivative include polyoxymethylene, polyoxyethylene, polyoxypropylene, polyoxyisopropylene and the like, and polyoxyethylene and polyoxypropylene are preferably used. These are suitably used from the viewpoint that a monomer after decomposition can be transpired at temperatures of 250° C. or more, leaving no waste.

The heat transpirable compound or heat decomposable compound (B) may be a copolymer obtained by two or more monomers. Examples of this copolymer include polyoxyalkylene copolymers such as a polyoxymethylene-polyoxyethylene copolymer, polyoxymethylene-polyoxypropylene copolymer, polyoxyethylene-polyoxypropylene copolymer and the like, a styrene-methacrylate copolymer and the like.

The heat transpirable compound or heat decomposable compound can be optionally selected within the range in which compatibility with the aromatic polymer or monomer (A) can be successfully maintained, and one or more of the compounds can be used in combination.

The weight-average molecular weight of the heat transpirable compound or heat decomposable compound (B) based on a polystyrene calibration standard according to GPC is preferably 50000 or less, more preferably 30000 or less, further preferably 10000 or less.

When this molecular weight is over 50000, a void formed may increase.

The composition of the present invention comprises (A) and (B), and an organic solvent may be further compounded to obtain an application solution.

The organic solvent is not particularly restricted providing it can dissolve (A) and (B). The examples include alcohols such as methanol, ethanol, isopropanol, 1-butanol, 2-ethoxymethanol, 3-methoxypropanol and the like, ketones such as acetylacetone, methyl ethyl ketone, methyl isobutyl ketone, 3-pentanone, 2-heptanone, 3-heptaanone, cyclohexanone and the like, esters such as propyl acetate, butyl acetate, isobutyl acetate, pentyl acetate, methyl propionate, ethyl propionate, methyl butyrate, propylene glycol monomethyl ether acetate, ethyl lactate and the like, ethers such as diisopropyl ether, dibutyl ether, dioxane, anisole, phenetole, veratole, diphenyl ether and the like, aromatic hydrocarbons such as benzene, toluene, mesitylene, ethylbenzene and the like, halogens such as chloroform, chlorobenzene, dichloroethylene, trichloroethylene and the like, amides such as N,N-dimethylformamide, N,N-diethylformamide, N,N-dimethylacetamide, N-methylpropionamide, N-methylpyrrolidone and the like, aliphatic hydrocarbons such as pentane, hexane, heptane and the like, and these are suitably used from the viewpoint of it easy availability.

These organic solvents can be properly selected within the range in which the solubility of (A) and (B), and the application property of an application solution itself can be successfully maintained, and one or more of them may be used in combination.

When an application solution prepared by compounding the organic solvent is used, the total solid concentration of the application solution, namely, [(compounding amount of (A)+compounding amount of (B))/(compounding amount of (A)+compounding amount (B)+compounding amount of organic solvent)]×100, is preferably 5 to 30%. This concentration can be appropriately controlled based on the thickness of an applied film and objects of improvement in leveling, and the like.

The weight ratio of the compounding amount of (A) to the compounding amount of (B) in the composition of the present invention is preferably from 99:1 to 1:99, more preferably from 95:5 to 30:70, further preferably from 95:5 to 50:50.

When the weight ratio of (A) is less than 1, the cross-linking temperature may not become low, and transpiration of a heat transpirable compound or decomposition of a heat decomposable compound may occur before cross-linking, further, the cross-linking density may decrease, consequently, voids formed may decrease and relative dielectric constant may not decrease sufficiently. On the other hand, when the weight ratio of (B) is over 99, compatibility of (A) and (B) may deteriorate and size of void formed may be large.

Into the composition and application solution of the present invention, an additive may be further added.

The additive includes, for example, coupling agents such as a silane coupling agent, titanium coupling agent and the like, surfactants, foam controlling agents, catalysts such as organic peroxides and the like.

A coupling agent may be added for enhancing close adherence with a substrate, and a surfactant may be added for an application property or stability in forming a porous structure, and a catalyst such as organic peroxides and the like may be added to decrease the cross-linking temperature of (A), respectively.

Into the composition and application solution of the present invention, an aromatic polymer having a cross-linkable group in the molecule may be compounded.

The aromatic polymer having a cross-linkable group in the molecule may be compounded for the purpose of giving compatibility of (A) and (B), enhancing flattening of an insulation film in porous structure formation, regulating the thickness of an insulation film, and the like.

The aromatic polymer having in the molecule a cross-likable group is not particularly restricted providing one or more cross-likable groups are contained in the molecule, and examples include polyphenylenes, polyimides, polyarylene ethers, polyarylene ether ketones, polyarylene ether sulfones, polyarylene ether amides and the like. Particularly, a polymer having an ether bond in the main chain is preferably used from the viewpoint of heat resistance, insulation property and solubility in a solvent, and among them, polyarylene ethers are more preferably used from the viewpoint of the relative dielectric constant of 3.0 or less.

The aromatic polymer having a cross-linkable group in the molecule may be a random copolymer or a block copolymer, and graft copolymers and block copolymers in which other polymer is bonded to the side chain or end group may also be used.

The group having the ability of cross-linking may exist on the side chain or end group.

The group having the ability of cross-linking include cross-linkable groups such as a cyanate group, propargyl group, allyl group, vinyl group, ethynyl group, alkylsilyl group, alkoxysilyl group and the like.

The weight-average molecular weight of the aromatic polymer having a cross-linkable group in the molecule based on a polystyrene calibration standard according to GPC is preferably 100000 or less, more preferably 50000 or less, further preferably 30000 or less.

The porous organic film can be formed by applying the composition of the present invention on a substrate, conducting a cross-linking reaction, then, conducting heat treatment at temperatures of Tb or more and Ta or less, to generate voids.

The temperature of the heat treatment is preferably 400° C. or less. By heating at 400° C. or less, the decomposition of (A) may be suppressed.

The substrate include substrates made of, for example, glass, quartz, metal, ceramic, silicone, GaAs, SiO₂, SiN, SiC.

The application method includes, for example, spin coating, roller coating, dip coating, spray method.

The application solution applied on a substrate is subjected to a cross-linking reaction of (A), then, a phase formed of (B) is heat-transpired or heat-decomposed at 400° C. or lower, or at temperatures of Tb or more and less than Ta, to generate voids having a pore diameter, preferably, of 0.1 μm or less, giving a porous structure.

Any temperature between Tb and Ta may be maintained at constant time.

The temperature of Tb or more and less than Ta is preferably 250° C. or more and 400° C. or less, more preferably 300° C. or more and 380° C. or less, further preferably 350° C. or more and 370° C. or less.

The method of cross-linking (A) include, for example, a heat treatment method, ultraviolet irradiation method and the like.

The heating method include, for example, methods using an oven, hot plate, furnace and the like, light irradiating heating using a xenon lamp by RTP (lamp heating heater) and the like, and other methods.

The heat treatment is conducted preferably in an atmosphere having an oxygen concentration of less than 1%, and more preferably in an atmosphere having an oxygen concentration of less than 100 ppm.

The atmosphere having an oxygen concentration of less than 1% is, for example, a pressure reduction atmosphere, inner gas atmosphere, atmosphere in vacuum, and the like.

The pressure reduction atmosphere is preferably from about 1 to 20 Pa.

As the inert gas atmosphere, for example, helium, nitrogen, argon and the like are listed.

A porous organic film obtained by using the composition of the present invention can be cross-linked at relatively lower temperature, so it can be produced easily in short time.

The porous organic film has low dielectric constant and is excellent in heat resistance and chemical resistance, therefore, it can be suitably used as an insulation film for electronic materials such as semiconductors and the like.

### EXAMPLES

The present invention will be illustrated further in detail based on examples, however, the present invention is not limited to those examples.

### Production Example 1

Synthesis of Aromatic Polymer A1

Into a 500 mL four-necked flask was charged 9,9-bis(4-dihydroxyphenyl)fluorene (9.6 g), 1-(trimethylsilylethynyl)-2,4-difluorobenzene (5.4 g), potassium carbonate (10.4 g), dimethyl sulfoxide (150 g) and toluene (80 g), then, they were reacted at 120° C. for 12 hours, at 130° C. for 2 hours, and at 150° C. for 4 hours. Thereafter, the reaction solution was added to a methanol/acetic acid solution, to precipitate a product. The precipitated resin was filtrated, then, washed with methanol and water, and dried to give a resin. The weigh-average molecular weight of the C≡C bond-containing aromatic polyether resin based on a polystyrene calibration standard was about 7600, and the ¹H NMR spectrum supported the fact that a trimethylsilyl group was released to give a HC≡C group. This is called aromatic polymer A1.

### Production Example 2

Synthesis of Compound A2

Into a 500 mL four-necked flask was charged 1,2,4,5-tetrabromobenzene (19.7 g) together with triethylamine (250 g) and Cu(I)I (1.1 g) without any treatment, and they were left under Ar flow for 1 hour. Pd(0) (TPP) ₄ (3.3 g), trimethylsilylacetylene (10.8 g) and phenylacetylene (11.3 g) were added, and the mixture was maintained at 80° C. for 6 hours while stirring, then, stirred at room temperature overnight. The solution was filtrated, the liquid layer was distilled off with a solvent, then, treated in a column with a toluene solvent, and concentrated to obtain a crystal. To this crystal were added 100 g of methanol and 50 g of toluene and they were dissolved, further potassium carbonate (41.5 g) was added and the mixture was stirred overnight. It was neutralized with acetic acid, and washed with water, then, concentrated to obtain the intended substance. This is called compound A2.

### Production Example 3

Synthesis of Compound A3

Into a 500 mL four-necked flask was charged 9,9-bis(4-dihydroxyphenyl)fluorene (28.0 g), 1-(phenylethynyl)-3,5-difluorobenzene (15.2 g), K₂CO₃ (29.6 g), dimethyl sulfoxide (429 g) and toluene (229 g), and the mixture was subjected to dehydration under reflux, then, reacted at 180° C. for 4 hours. Then, the reaction solution was added to a methanol/acetic acid solution to precipitate a product. The precipitated resin was filtrated, then, washed with methanol and water, and dried to obtain a resin. The weigh-average molecular weight of the C≡C bond-containing aromatic polyether resin based on a polystyrene calibration standard was about 8500, and this is called compound A3.

### Production Example 4

Synthesis of Compound A4

Into a 500 mL four-necked flask was charged 2,4-diboromophenol (25.2 g, 0.1 mol), difluorobenzophenone (10.9 g, 0.05 mol), potassium carbonate (20.7 g, 0.15 mol), 150 g of dimethyl sulfoxide and 80 g of toluene, and they were heated at 150° C. under N₂ flow for 6 hours while stirring. To the reaction mass was added toluene and the solution was washed with water, and subjected to distillation with a solvent to obtain a resinous substance. The resulted resin (17.0 g, 0.025 mol) was charged into a 500 mL four-necked flask together with 200 g of triethylamine and Cu(I)I (0.6 g, 0.003 mol) without any treatment, and the mixture was left under Ar flow for 1 hour. Pd(0) (TPP)₄ (1.7 g, 0.0015 mol), and ethynylbenzene (12.4 g, 0.12 mol) were added, and the mixture was maintained at 80° C. for 6 hours while stirring, then, stirred at room temperature overnight. The solution was filtrated, the liquid layer was distilled off with a solvent, then, treated in a column with a toluene solvent, and concentrated to obtain the intended substance. This is called compound A4.

### Production Example 5

Synthesis of Compound A5

Into a 200 mL four-necked flask was charged 5.0 g (17 mmol) of diboromoadamantane, 2.3 g (9 mmol) of aluminum bromide and 100 mL of m-dibromobenzene, and they were stirred at 60° C. for 10 hours. After cooling, the reaction solution was added into 150 g of ice water containing 10 g of concentrated hydrochloric acid dissolved therein, the mixture was stirred, then, the aqueous phase was removed. Excess dibromobenzene was removed by distillation under reduced pressure, then, 100 mL of methylene chloride was added and dissolved in the residue, and the solution was washed with water and saline, then, dried over magnesium sulfate. The drying agent was filtrated off, then, methylene chloride was concentrated by an evaporator, and 100 mL of methanol was added and the mixture was stirred. The deposited crystal was filtrated, and dried under reduced pressure. 6.0 g of this crystal was charged into a 200 mL four-necked flask, and 200 mg of dichlorobis(triphenylphosphine) palladium, 400 mg of tripheylphosphine, 180 mg of copper iodide (I) and 100 mL of triethylamine were added, and the mixture was heated up to 70 to 80° C. 6.7 g of trimethylsilylacetylene was dropped over 1 hour, and they were reacted at the same temperature for 4 hours. After cooling, the solvent was distilled off, 200 mL of diethyl ether was added to the residue, and an insoluble salt was filtrated. The filtrate was washed with 1N hydrochloric acid, saturated saline and ultrapure water, and the ether phase was dried over magnesium sulfate. The drying agent was filtrated off, ether was distilled off, and the residue was purified in a column (stationary phase; silica gel 60, developing liquid; hexane/methylene chloride). 5.9 g of the main product was dissolved in 150 mL of methanol and 100 mL of tetrahydrofuran, and 0.5 g of potassium carbonate was added and the mixture was stirred at room temperature for 4 hours. The solvent was distilled under reduced pressure, and 200 mL of methylene and 100 mL of 1N hydrochloric acid were added to the residue, and the solution was stirred, then, the hydrochloric acid phase was removed. The hydrochloric acid phase was washed three times with 100 mL of ultrapure water, the solvent was distilled off from the methylene chloride phase and the resulted solution was dried under reduced pressure, to obtain 3.2 g of bis(diethynylphenyl)adamantane. This is called compound A5.

### Production Example 6

Synthesis of Compound A6

Into a 1000 mL four-necked flask was charged 30.0 g (102 mmol) of diboromoadamantane, 160.2 g (1.02 mol) of bromobenzene and 570 g of dichloromethane, and the mixture was cooled to 5° C. with ice water. To this was added 0.83 g (5.1 mmol) of anhydrous iron chloride (III), and stirring of the mixture was continued over 12 hours while heating up to room temperature. The reaction solution was added to 300 g of 1N hydrochloric acid, and the mixture was stirred, then, the aqueous layer was removed. The organic layer was washed one time with 100 g of 1N hydrochloric acid, further, washed four times with 100 g of ion exchanged water. Dichloromethane and excess bromobenzene were removed by distillation under reduced pressure, then, to the residue was added 300 g of methanol, and the mixture was stirred. The precipitated oil was removed, 30 g of tetrahydrofuran was added and dissolved therein, and dropped into 300 g of methanol. The precipitated oil was removed and dried under reduced pressure, to obtain 38.5 g of an oil. 37.4 g of this oil was charged into a 1000 mL of four-necked flask, and 4.36 g of tetrakis(tripheylphosphine) palladium, 1.44 g of copper iodide (I) and 374 g of triethylamine were added, and dissolved in the oil. Into this, 41.2 g of trimethylsilylacetylene was dropped over 1 hour, and the mixture was heated up to 80° C. At the same temperature, they were reacted for 8 hours, further, cooled to room temperature, then, stirring thereof was continued for 16 hours. An insoluble substance was filtrated, and washed with 150 g of toluene. The filtrate and the washing liquid were mixed and concentrated, and the residue was purified in a column (stationary phase; silica gel 60, developing liquid; hexane/toluene). 7.80 g of the main product was dissolved in a mixed solvent of 78 g of methanol and 234 g of tetrahydrofuran, and 1.65 g of potassium carbonate was added, and the mixture was stirred at room temperature for 10 hours. The solvent was distilled off under reduced pressure, and to the residue was added 80 g of toluene and 30 g of 1N hydrochloric acid, and they were stirred, then, the aqueous phase was removed. Further, 20 g of 1N hydrochloric acid was added, and the mixture was stirred, then, the aqueous layer was removed. The organic layer was washed three times with 30 mL of ion exchanged water, and toluene was distilled off under reduced pressure. 4.2 g of 1,3,5-tris(¾-ethynylphenyl)adamantane was obtained. This is called compound A6.

### Production Example 7

Synthesis of Compound A7

Into a 500 mL four-necked flask was charged 6.4 g (20 mmol) of 1,3-bis(4-hydroxyphenyl)adamanntane, 10.4 g (41 mmol) of 1,3-dibromo-5-fluorobenzene and 22.4 g (60 mmol) of potassium carbonate, 168 g of toluene and 84 g of dimethyl sulfoxide were charged, and the temperature was gradually raised up to 120° C., and the mixture was kept at this temperature for 45 hours. After cooling to room temperature, 150 g of ion exchanged water and 21 g of acetic acid were added, the mixture was stirred, then, the aqueous layer was removed. The organic layer was further washed with 100 g of ion exchanged water, and the resulted solution was concentrated under reduced pressure. To this was added 20 g of toluene and the mixture was heated up to 60° C., and 70 g of methanol was added to this and the resulted mixture was cooled gradually to room temperature. The deposited crystal was filtrated, and the resulted solution was washed with 100 g of methanol. 15.4 g of 1,3-bis(4-(3,5-dibromophenyloxy)phenyl)adamantane was obtained as a white crystal. 14.2 g (18 mmol) of 1,3-bis(4-(3,5-dibromophenyloxy)phenyl)adamantane was charged into a 500 mL four-necked flask, and 0.62 g of tetrakis(triphenylphosphine) palladium, 0.21 g of copper iodide (I) and 142 g of triethylamine and 100 g of toluene were added. Into this was dropped 10.6 g of trimethylsilylacetylene over 1 hour, and the mixture was heated up to 80° C. They were reacted at the same temperature for 40 hours. During this, 3.7 g of trimethylsilylacetylene and 3.6 g of trimethylsilylacetylene were added respectively at 12 hours and 26 hours. After cooling to room temperature, an insoluble substance was filtrated, and the resulted solution was washed with 120 g of toluene. The filtrate and washing liquid were mixed and concentrated, and the residue was purified in a column (stationary phase; silica gel 60, development liquid; hexane/toluene). 12.6 of 1,3-bis(4-(3,5-bis(trimethylsilylethynyl)phenyloxy)phenyl)adamantane was obtained as the main product. 12.0 g (14 mmol) of 1,3-bis(4-(3,5-bis(trimethylsilylethynyl)phenyloxy)phenyl)adamantane was dissolved in a mixed solvent of 120 g of methanol and 240 g of tetrahydrofuran, and 1.93 g of potassium carbonate was added to this and the mixture was stirred at room temperature for 10 hours. The solvent was distilled off under reduced pressure, 50 g of toluene was added to the residue, and 2.4 g of acetic acid and 25 g of ion exchanged water were added for neutralization, and the aqueous layer was removed. The organic layer was washed once with 20 g of 1N hydrochloric acid and four times with 25 mL of ion exchanged water. Further, it was washed twice with 30 g of 1% oxalic acid water and four times with 20 mL of ion exchanged water, and toluene was distilled under reduced pressure. 50 g of methanol was added to the residue. The crystal was filtrated, and washed with 50 g methanol. 6.4 g of 1,3-bis(4-(3,5-diethynylphenyloxy)phenyl)adamantane was obtained. This is called compound A7.

### Production Example 8

Synthesis of Polymer A4

Into a 500 mL four-necked flask was charged 9,9-bis(4-dihydroxyphenyl)fluorene (28.0 g), 1-(phenylethynyl)-3,5-difluorobenzene (15.2 g), K₂CO₃ (29.6 g), dimethyl sulfoxide (429 g) and toluene (229 g), and the mixture was dehydrated under reflux, then, reacted at 180° C. for 4 hours. Then, the reaction solution was added into a methanol/acetic acid solution, and the product was precipitated. The precipitated resin was filtrated, then, washed with methanol and water, and dried to obtain a resin. The weigh-average molecular weight of the C≡C bond-containing aromatic polymer based on a polystyrene calibration standard was about 8500, and this is called aromatic polymer A8.

### Production Example 9

Synthesis of Heat Decomposable Compound B1

Into a nitrogen-purged 2 L flask was charged α-methystyrene (284 g), dichloromethane (284 g) and hexane (852 g), and the mixture was cooled to −60° C. Then, concentrated sulfuric acid (24 g) was charged. The mixture was kept at −60° C. for 1 hour, then, methanol (24 g) was charged, and the reaction was terminated. The solution was heated up to room temperature, and diluted with dichloromethane (353 g), then, washed with water. After liquid separation, the resulted resin solution (6000 g) was dropped into methanol to precipitate a resin which was filtrated out (205 g). This resin had a weight-average molecular weight based on a polystyrene calibration standard of about 4600. This is called heat decomposable compound B1.

### Production Example 10

Synthesis of Heat Decomposable Compound B2

Into a nitrogen-purged flask was charged 284 parts by weight of tetrahydrofuran and 72 parts by weight α-methystyrene. 54 parts by weight of a n-butyllithium solution was dropped into the flask while stirring. Then, the flask was cooled to −60° C., and the content was stirred for 30 minutes. Then, 165 parts by weight of a 20% tetrahydrofuran solution was dropped into the flask, and the mixture was stirred for 30 minutes. Finally, 6 parts by weight of methanol was charged, and the reaction was terminated. The mixture was heated up to room temperature, and the resulted resin solution was dropped into 4000 parts by weight of methanol to precipitate a resin which was filtrated out. Poly α-methylstyrene having a weight-average molecular weight of which end had been modified with diphenyl ethylene was obtained. This is called compound B2.

### Examples 1 to 2, Comparative Examples 1 to 6

The aromatic polymer A1, compounds A2 to A4 obtained in Production Examples 1 to 4, and the heat decomposable compound B1 obtained in Production Example 9 were dissolved at a weight ratio shown in Table 1 into anisole so that the total solid content was 15 wt %. Further, the prepared solution was filtrated by a known method through a 0.1 μm PTFE filter, to prepare application solutions 9 to 16.

The prepared application solution was dropped in an amount of about 1 ml on a 4 inch silicon water. Then, this wafer was spun at 500 rpm for 3 seconds, then, spun at 2000 rpm for 15 seconds. The coated wafer was baked at 150° C. for 1 minute. Then, the baked water was kept at 400° C. for 30 minutes under a nitrogen atmosphere in a furnace to cause hardening of the wafer to decompose a heat decomposition element. The relative dielectric constant of the resulted hardened film was measured by a mercury probe method using C-V measurement at a motion frequency of 1 MHz (manufactured by SSM, SSM 495 type). The results are summarized in Table 1.

TABLE 1

| | Application | | | Organic | | k value |
|---|---|---|---|---|---|---|
| | solution | A | B | solvent | A:B | (1 MHz) |
| Example 1 | Application | A1 | B1 | anisole | 65:35 | 2.35 |
| | solution 1 | | | | | |
| Example 2 | Application | A2 | B1 | anisole | 65:35 | 1.67 |
| | solution 2 | | | | | |
| Comparative | Application | A1 | — | anisole | 100:0 | 3.05 |
| example 1 | solution 3 | | | | | |
| Comparative | Application | A2 | — | anisole | 100:0 | 3.20 |
| example 2 | solution 4 | | | | | |
| Comparative | Application | A3 | — | anisole | 100:0 | 2.83 |
| example 3 | solution 5 | | | | | |
| Comparative | Application | A4 | — | anisole | 100:0 | 2.92 |
| example 4 | solution 6 | | | | | |
| Comparative | Application | A3 | B1 | anisole | 65:35 | 2.80 |
| example 5 | solution 7 | | | | | |
| Comparative | Application | A4 | B1 | anisole | 65:35 | 2.90 |
| example 6 | solution 8 | | | | | |

The relative dielectric constants of the films in Examples 1 to 2 were from 1.6 to 2.4 significantly lower than those in Comparative Examples 1 to 4 in which a heat decomposable compound was not compounded and in Comparative Examples 5 to 6 in which a heat decomposable compound was compounded in a compound having no —C≡CH group. Examples 3 to 6, Comparative Examples 7 to 10

The compounds A5 to A7 obtained in Production Examples 5 to 8, the aromatic polymer A2 and the heat decomposable compound B2 obtained in Production Example 10 were compounded and dissolved in an anisole so that the total solid content was 15 wt % and the weight ratio of solid components was as shown in Table 2. This solution was filtrated by a known method through a 0.1 μm PTFE film, to prepare application solutions 9 to 16.

The prepared application solutions 9 to 16 were dropped in an amount of about 1 ml on a 4 inch silicone water. Then, this wafer was spun at 500 rpm for 3 seconds, then, spun at 2000 rpm for 15 seconds. The coated wafer was baked at 150° C. for 1 minute. Then, the baked water was kept at 400° C. for 30 minutes under a nitrogen atmosphere in a furnace to cause hardening of the wafer to decompose a heat decomposition element. The relative dielectric constant of the resulted hardened film was measured by a mercury probe method using C-V measurement at a motion frequency of 1 MHz (manufactured by SSM, SSM 495 type). Hardness and elastic modulus were measured using Hysitoron TriboScope Micromechanical Test apparatus manufactured by HYSITRON. The results are shown in Table 3.

TABLE 2

Solid component compounding
weight ratio
(total solid concentration: 15 wt %)

| | |
|---|---|
| Component (A) | Component (B) |

| | A5 | A6 | A7 | A8 | B2 |
|---|---|---|---|---|---|
| Application | 70 | | | | 30 |
| solution 9 | | | | | |
| Application | | 65 | | | 35 |
| solution 10 | | | | | |
| Application | | 65 | | | 35 |
| solution 11 | | | | | |
| Application | 26 | | | 39 | 35 |
| solution 12 | | | | | |
| Application | 100 | | | | 0 |
| solution 13 | | | | | |
| Application | | 100 | | | 0 |
| solution 14 | | | | | |
| Application | | | 100 | | 0 |
| solution 15 | | | | | |
| Application | 40 | | | 60 | 0 |
| solution 16 | | | | | |

TABLE 3

| | Application | k value | Harness | Elastic |
|---|---|---|---|---|
| | solution | (1 MHz) | (GPa) | modulus (GPa) |
| Example 3 | Application | 2.08 | 1.1 | 8.6 |
| | solution 1 | | | |
| Example 4 | Application | 1.93 | | |
| | solution 2 | | | |
| Example 5 | Application | 1.97 | | |
| | solution 3 | | | |
| Example 6 | Application | 2.28 | 0.4 | 6.0 |
| | solution 4 | | | |
| Comparative | Application | 2.80 | 3.1 | 22 |
| example 7 | solution 5 | | | |
| Comparative | Application | 2.72 | 2.0 | 15 |
| example 8 | solution 6 | | | |
| Comparative | Application | 2.97 | 1.8 | 14 |
| example 9 | solution 7 | | | |
| Comparative | Application | 2.90 | 0.6 | 8.2 |
| example 10 | solution 8 | | | |

The relative dielectric constants of the films in Examples 3 to 5 and in Example 6 in which a polymer was compounded were from 1.9 to 2.3 significantly lower than those in Comparative Examples 7 to 8 in which a heat decomposable compound was not compounded.

According to the present invention, a composition for porous organic film from provide an insulation film of low dielectric constant.

1. A composition comprising the following (A) and (B):
(A) at least one selected form the group consisting of an aromatic polymer having a repeating unit of the following formula (1) and a monomer having in the molecule at least two —C≡CH groups,
(B) at least one selected form the group consisting of a heat transpirable compound and a heat decomposable compound: 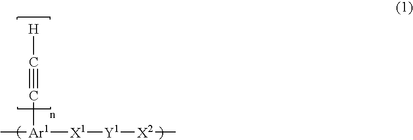
(in the formula (1), Ar¹ represents a group having an aromatic ring optionally substituted by other group than a —C≡CH group, X¹ and X² each independently represents a direct bond, an alkylene group having 1 to 20 carbon atoms optionally substituted, —CR¹═CR²—, —C≡C—, a divalent group having an aromatic ring optionally substituted, a divalent group having an alicyclic hydrocarbon ring optionally substituted, —O—, —CO—, —COO—, —S—, —SO—, —SO₂—, —NR³— or —CONR⁴—, R¹ to R⁴ each independently represents a hydrogen atom or an alkyl group having 1 to 20 carbon atoms optionally substituted, an alkoxy group having 1 to 20 carbon atoms optionally substituted, an alicyclic hydrocarbon group having 4 to 20 carbon atoms optionally substituted or an aryl group optionally substituted, and Y¹ represents a divalent organic group. n represents an integer of 1 or more.).

2. The composition according to claim 1, wherein Y¹ represents a divalent group having an aromatic ring optionally substituted.

3. The composition according to claim 1, wherein the aromatic polymer is a polyarylene ether derivative.

4. The composition according to claim 1, wherein the monomer having in the molecule at least two —C≡CH groups further has an aromatic ring.

5. The composition according to claim 1, wherein the monomer having in the molecule at least two —C≡CH groups is a compound selected from the group consisting of the groups (4) and a compound of the formula (5): 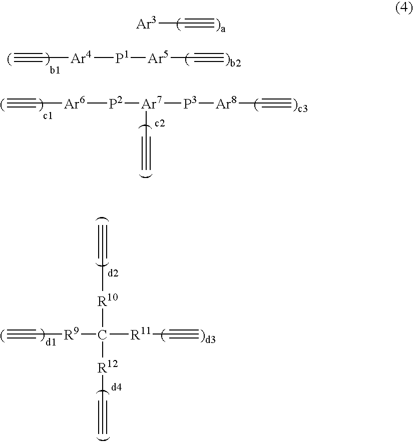
(in the above, Ar³ to Ar⁸ each independently represents a group having an aromatic ring optionally substituted by other group than a —C≡C—H group, R⁹ to R¹² each independently represents a hydrogen atom or an alkyl group having 1 to 20 carbon atoms, an alkoxy group having 1 to 20 carbon atoms, an alicyclic hydrocarbon group having 4 to 20 carbon atoms, an aryl group or a hydroxyl group, and the alkyl group having 1 to 20 carbon atoms, alkoxy group having 1 to 20 carbon atoms, alicyclic hydrocarbon group having 4 to 20 carbon atoms and aryl group may be substituted by other group than a —C≡C—H group,
at least one of R⁹ to R¹² is selected from groups having an aromatic ring optionally substituted by other group than a —C≡C—H group, a represents an integer of 2 or more, b1, b2, c1 to c3 and d1 to d4 each independently represents an integer of 0 or more, and b1+b2, c1+c2+c3 and d1+d2+d3+d4 represent an integer of 2 or more.) 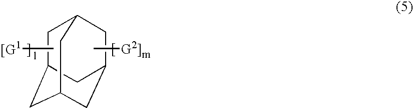
(in the formula (5), G¹ s may be mutually the same or different, and represent an ethynyl group, an organic group of the formula (6) or an organic group of the formula (7), when a plurality of G²s are present, they may be mutually the same or different, and represent a hydrogen atom, halogen atom, hydroxyl group, alkyl group having 1 to 6 carbon atoms, alkoxy group having 1 to 6 carbon atoms, phenoxy group or aryl group optionally substituted, 1 represents an integer of 2 to 16 and m=16-1.)
—T^{1—Ar}⁹—(C≡C—A)ₚ (6)
(in the formula (6), T¹ represents a direct bond, an alkylene group having 1 to 6 carbon atoms, alkenylene group having 2 to 6 carbon atoms or an alkynylene group having 2 to 6 carbon atoms, p represents an integer of 1 to 5, Ar⁹ represents an arylene group optionally substituted, A represents a hydrogen atom or an aryl group optionally substituted, and when p is 2 or more, As may be the same or different, however, at least one of them is a hydrogen atom.)
—Ar¹⁰—T²—Ar¹¹—(C≡C—B)_{q} (7)
(wherein, q represents an integer of 1 to 5, and Ar¹⁰ and Ar¹¹ represent an arylene group optionally substituted, T² represents —O—, —CO—, —COO—, —S—, —SO— or —SO₂—, B represents a hydrogen atom or an aryl group optionally substituted, and when q is 2 or more, Bs may be the same or different, however, at least one of them is a hydrogen atom.).

6. The composition according to claim 1, wherein the monomer having in the molecule at least two —C≡CH groups is represented by the formula (5).

7. The composition according to claim 6, wherein G¹ is a monovalent organic group selected from the following group:
—C≡CH
—Ar⁹C≡CA)ₚ—C≡C—Ar⁹C≡CA)ₚ
—Ar¹⁰—O—Ar¹¹C≡CB)_{q}—Ar¹⁰—CO—Ar¹¹C≡CB)_{q}
(wherein, Ar⁹, Ar¹⁰, Ar ¹¹, A, B, p and q are as defined above.).

8. The composition according to claim 6, wherein G¹ is an organic group selected from the following group: 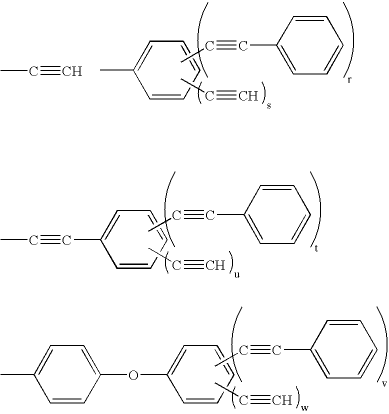
(wherein, r, t and v represent an integer of 0 to 5, s, u and w represents an integer of 1 to 5, r+s represents 1 to 5, t+u represents 1 to 5 and v+w represents 1 to 5.).

9. The composition according to claim 6, wherein G¹ is an organic group selected from the following group:

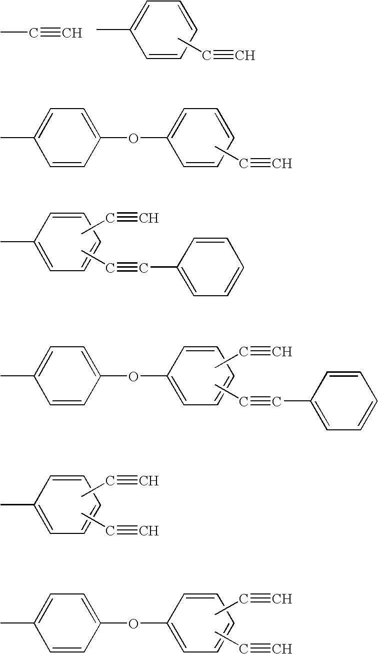

10. The composition according to claim 6, wherein the compound of the formula (5) is selected from compounds (8) 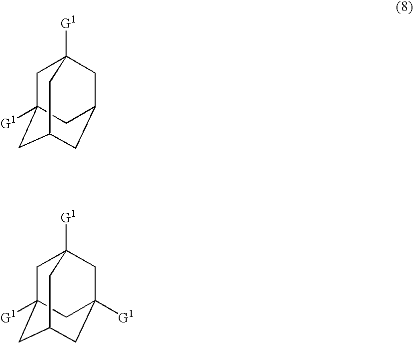
(wherein, G¹ is as defined above.).

11. The composition according to claim 1, wherein the heat decomposable compound is one selected from the group consisiting of polystyrene, poly α-methylstyrene, polyoxyethylene and polyoxypropylene.

12. The composition according to claim 1, wherein the heat decomposition initiation temperature Ta of (A) and the heat transpiration or heat decomposition initiation temperature Tb of (B) satisfy the relation of Ta>Tb.

13. The composition according to claim 1, wherein the weight-average molecular weight of (B) is 50000 or less based on a polystyrene calibration standard.

14. A method of forming a porous organic film comprising applying the composition according to claim 1 on a substrate, then, heat-treating.

15. The formation method according to claim 14 wherein heat treatment is conducted at an oxygen concentration of less than 1%.

16. The formation method according to claim 14, wherein the heat-treating is conducted under reduced pressure, inert gas atmosphere or vacuum.

17. The formation method according to claim 14, wherein the heat-treating is conducted at 400° C. or lower.

18. A porous organic insulation film obtained by the formation method according to any one of claims 14.
